(19) United States
(12) Patent Application Publication
(10) Pub. No.: US 2025/0141819 A1
(43) Pub. Date: May 1, 2025

(54) Management System For Handling Inquiries

(71) Applicant: TAISHO SKY BUILDING, INC., Tokyo (JP)

(72) Inventor: Kazuharu Ishida, Tokyo (JP)

(21) Appl. No.: 19/006,190

(22) Filed: Dec. 30, 2024

Related U.S. Application Data
(63) Continuation of application No. PCT/JP2022/026206, filed on Jun. 30, 2022.

(51) Int. Cl. H04L 51/02; G06Q 40/04

(52) U.S. Cl. CPC H04L 51/02; G06Q 40/04

(57) ABSTRACT

An inquiry response management system includes a management server that manages commodities being inquiry response targets. The management server includes a question receiving unit, a situation acquisition unit, an answer generation unit, and an answer transmission unit. The question receiving unit receives a user's question about a commodity via a terminal device. If the question receiving unit receives the user's question, the situation acquisition unit acquires a situation of the user related to the commodity in accordance with the user's question. The answer generation unit generates an answer to the user's question based on the situation of the user acquired by the situation acquisition unit and the commodity information stored in the storage unit. The answer transmission unit transmits the answers generated by the answer generation unit to the terminal device.

### RELATED APPLICATIONS

The present application is a continuation of International Patent Application No. PCT/JP2022/026206, filed Jun. 30, 2022, which is hereby incorporated by reference in its entirety.

### TECHNICAL FIELD

This disclosure relates to an inquiry response management system that responds to human inquiries.

### BACKGROUND

A system for renting rooms of a building (e.g., an office, a hotel, or the like) to users typically includes a management server open to a communication network such as the Internet, and a plurality of reservation servers in which information on the conference room is stored. Such a system is typically configured so that users can access information describing the conference room in a reservation server via the management server and reserve a desired conference room. Such a system also typically has a billing function so that a rental fee can be paid online.

Incidentally, an automated conversation system that automatically responds to human inquiries through a chatbot that uses an artificial intelligence (AI) technology has attracted attention in recent years. Such a chatbot that uses AI technology is designed to be capable of appropriately responding to human inquiries by training the AI based on past questions and answers using technologies including deep learning.

However, conventional chatbots that use AI technology respond with uniform answers based on a learning result based on past questions and answers regardless of the current situations of questioners. Therefore, for example, a uniform answer may be given as a response to an inquiry about a conference room that is a reserved commodity in conventional systems despite which conference room the user has reserved, which decreases user convenience.

### SUMMARY

An object of the present disclosure is to provide an inquiry response management system that improves user convenience.

An inquiry response management system of the present disclosure is an inquiry response management system including a management server configured to manage commodities being inquiry response targets; and a user input means connected to the management server via a communication line and configured to accept input of information by a user of a commodity, wherein the management server includes a storage unit configured to store commodity information on the commodities; a question receiving unit configured to receive the user's question about the commodity via the user input means; a situation acquisition unit configured to, upon the question receiving unit receiving the user's question, acquire a situation of the user related to the commodity in accordance with the user's question; an answer generation unit configured to generate an answer to the user's question based on the situation of the user acquired by the situation acquisition unit and the commodity information stored in the storage unit; and an answer transmission unit configured to transmit the answer generated by the answer generation unit to the user input means.

According to such a configuration, the management server includes the situation acquisition unit configured to, upon the question receiving unit receiving the user's question, acquire the situation of the user related to the commodity in accordance with the user's question; and the answer generation unit configured to generate an answer to the user's question based on the situation of the user acquired by the situation acquisition unit and the commodity information stored in the storage unit. Therefore, the answer generation unit can appropriately generate an answer to the user's question in accordance with the situation of the user, and the answer transmission unit can transmit the answer to the user input means. Therefore, the inquiry response management system can transmit an appropriate answer to the user's question in accordance with the situation of the user to the user input means, and can improve user convenience.

In the present disclosure, it is preferable that the management server include: a reservation information setting unit configured to store and set, in the storage unit, reservation information on the user of and a date and time for use of the commodity by accepting a reservation for the commodity via the user input means, and the situation acquisition unit acquire the situation of the user related to the reservation information stored in the storage unit in accordance with the user's question.

Here, it is assumed that examples of the user of the commodity include not only a user who has reserved the commodity but also all users of the commodity. If the commodity is, for example, a facility such as a conference room or a rental space, it is assumed that examples of the user of the commodity include not only a user who has reserved the facility (such as an event organizer) but also a user who uses the facility (such as a participant in the event), and a user who has the authority to unlock a lock of the facility (a user who has been authorized by the user who has made the reservation).

According to the present disclosure, the situation acquisition unit acquires the situation of the user related to the reservation information stored in the storage unit in accordance with the user's question. Therefore, the answer generation unit can appropriately generate an answer to the user's question in accordance with the situation of the user related to the reservation information stored in the storage unit, and it is possible to further improve user convenience.

In the present disclosure, it is preferable that the situation acquisition unit acquire information on whether or not the user has reserved the commodity, as the situation of the user, based on the user related to the question received by the question receiving unit and the reservation information stored in the storage unit, and the answer generation unit generate an answer about the reserved commodity upon the situation acquisition unit acquiring information that the user has reserved the commodity, as the situation of the user.

According to such a configuration, when the situation acquisition unit acquires the information that the user has reserved the commodity, as the situation of the user, the answer generation unit generates an answer about the reserved commodity. Therefore, when the commodity is, for example, a facility, it is possible to generate, for example, information on the location of the reserved facility, information on a key for using the reserved facility, or information on a device installed in the reserved facility and use instructions for the device, as the answer to the user's question.

In the present disclosure, it is preferable that upon acquiring information that the user has reserved commodities, as the situation of the user, the situation acquisition unit cause the user to select at least one of the plurality of reserved commodities.

According to such a configuration, upon acquiring the information that the user has reserved the commodities, as the situation of the user, the situation acquisition unit causes the user to select at least one of the plurality of reserved commodities. Therefore, it is also possible to appropriately answer to a question of the user who has reserved the plurality of commodities.

In the present disclosure, it is preferable that upon acquiring the information that the user has reserved the commodity, as the situation of the user, the situation acquisition unit acquire information on whether or not the user is using the commodity, as the situation of the user, based on a date and time when the question receiving unit received the question and the date and time for use stored in the storage unit, and upon the situation acquisition unit acquiring information that the user is using the commodity, as the situation of the user, the answer generation unit generate an answer about the commodity currently in use.

According to such a configuration, when the situation acquisition unit acquires the information that the user is using the commodity, as the situation of the user, the answer generation unit generates an answer about the commodity currently in use. Therefore, when the commodity is, for example, a facility, it is possible to generate information on, for example, a device installed in the facility currently in use, a position where the device is installed, or use instructions for the device, as the answer to the user's question.

In the present disclosure, it is preferable that a facility as a commodity connected to the management server and the user input means via the communication line be included, the management server include a user position acquisition unit configured to acquire a position of the user related to the question received by the question receiving unit, upon acquiring information that the user has reserved the facility, as the situation of the user, the situation acquisition unit acquire information on whether or not the user is using the facility, as the situation of the user, based on the position of the user acquired by the user position acquisition unit and a position of the reserved facility, and upon the situation acquisition unit acquiring information that the user is using the facility, as the situation of the user, the answer generation unit generate an answer about the facility currently in use.

Here, in a case of a facility that the user can enter, such as a conference room or rental space, a method in which the situation acquisition unit acquires the information that the user is using the facility, as the situation of the user, when the position of the user is in or near the facility, can be exemplified as a method for acquiring the information on whether or not the user is using the facility, as the situation of the user, based on the position of the user and the position of the reserved facility.

Note that, in a case of a facility that a user of, for example, a rental article cannot enter, the situation acquisition unit may be configured in such a manner as to, upon the position of the user being near the facility, acquire the information that the user is using the facility, as the situation of the user.

According to the present disclosure, upon the situation acquisition unit acquiring the information that the user is using the facility, as the situation of the user, the answer generation unit generates an answer about the facility currently in use. Therefore, it is possible to generate information on, for example, a device installed in the facility currently in use, a position where the device is installed, or use instructions for the device, as the answer to the user's question.

In the present disclosure, it is preferable that the facility include a lock device that locks and unlocks the facility, and upon the lock device of the facility being unlocked properly, the user position acquisition unit acquire the position of the facility as the position of the user.

According to such a configuration, when the lock device of the facility has been unlocked properly, the user position acquisition unit acquires the position of the facility as the position of the user. Therefore, it is possible to easily identify the position of the user without providing a new device or function to acquire the position of the user.

In the present disclosure, it is preferable that the management server include a mobile object position acquisition unit configured to acquire a position of a mobile object installed in the facility, and the answer generation unit generate an answer about the position of the mobile object acquired by the mobile object position acquisition unit.

According to such a configuration, the answer generation unit generates an answer about the position of the mobile object acquired by the mobile object position acquisition unit. Therefore, the user can easily grasp the position of the mobile object installed in the facility.

In the present disclosure, it is preferable that the management server include a device operating unit configured to operate a device installed in the facility, and the answer generation unit generate an answer about the device operated by the device operating unit.

According to such a configuration, the management server includes the device operating unit configured to operate the device installed in the facility, and the answer generation unit generates an answer about the device operated by the device operating unit. Therefore, it is possible to appropriately answer to a question about the operation of the device installed in the facility, for example, by actually operating the device.

In the present disclosure, it is preferable that the management server include an operating state acquisition unit configured to acquire an operating state of the device installed in the facility, and the answer generation unit generate an answer about the operating state of the device acquired by the operating state acquisition unit.

According to such a configuration, the management server includes the operating state acquisition unit configured to acquire the operating state of the device installed in the facility, and the answer generation unit generates an answer about the operating state of the device acquired by the operating state acquisition unit. Therefore, it is possible to appropriately answer to, for example, a question about a malfunction in the device installed in the facility.

In the present disclosure, it is preferable that, upon the situation acquisition unit acquiring the information that the user is using the commodity, as the situation of the user, the answer generation unit generate an answer about an extension to a use time of the commodity currently in use.

According to such a configuration, when the situation acquisition unit acquires the information that the user is using the commodity, as the situation of the user, the answer generation unit generates an answer about the extension to the use time of the commodity currently in use. Therefore, the user can inquire and check whether or not the use time of the commodity currently in use can be extended.

In the present disclosure, it is preferable that the answer generation unit grasp an available time slot(s) for the commodity based on the reservation information stored in the storage unit, and cause the user to select whether or not to extend the use time based on the available time slot(s) for the commodity.

According to such a configuration, the answer generation unit grasps the available time slot(s) for the commodity based on the reservation information stored in the storage unit, and causes the user to select whether or not to extend the use time based on the available time slot(s) for the commodity. Therefore, the user can make an arrangement to extend the use time by selecting whether or not to extend the use time via the inquiry response management system.

In the present disclosure, it is preferable that a facility as a commodity connected to the management server and the user input means via the communication line be included, the situation acquisition unit acquire information on whether or not there is a record of a reservation for the facility, as the situation of the user, based on the user related to the question received by the question receiving unit and the reservation information stored in the storage unit, and upon the situation acquisition unit acquiring information that there is the record of the reservation for the facility, as the situation of the user, the answer generation unit generate an answer about the facility having the record of the reservation.

According to such a configuration, when the situation acquisition unit acquires the information that there is the record of the reservation for the facility, as the situation of the user, the answer generation unit generates an answer about the facility having the record of the reservation. Therefore, it is possible to appropriately answer, for example, a question about the facility that the user used, after the date and time for use.

In the present disclosure, it is preferable that the answer generation unit generate an answer about an unlock key for unlocking a lock of the facility, as the answer about the facility having the record of the reservation.

According to such a configuration, the answer generation unit generates an answer about the unlock key for unlocking the lock of the facility, as the answer about the facility having the record of the reservation. Therefore, it is possible to generate an answer about the unlock key, for example, in a case of going back to the facility used by the user to get something that the user left behind, after the date and time for use. Therefore, the inquiry response management system can transmit an appropriate answer to the user's question in accordance with the situation of the user to the user input means, and can improve user convenience.

In the present disclosure, it is preferable that the answer generation unit grasp an available time slot(s) for the facility based on the reservation information stored in the storage unit, and generate an answer about an unlock key for unlocking the lock of the facility in the available time slot for the facility.

According to such a configuration, the answer generation unit grasps the available time slot(s) for the facility based on the reservation information stored in the storage unit, and generates an answer about the unlock key for unlocking the lock of the facility in the available time slot for the facility. Therefore, it is possible to prevent generation of an answer about an unlock key for unlocking the lock of the facility that is being used by another user.

In the present disclosure, it is preferable that the answer generation unit cause the user to select at least one of the available time slots for the facility being a target for generating an answer about an unlock key.

According to such a configuration, the answer generation unit causes the user to select at least one of the available time slots for the facility being the target for generating the answer about the unlock key. Therefore, the user can select an available time slot for the facility being the target for generating an answer about an unlock key at his/her own convenience.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 is a schematic configuration diagram of an inquiry response management system according to an embodiment of the present disclosure.

FIG. 2 is a functional block diagram illustrating a schematic configuration of the inquiry response management system.

FIG. 3 is a diagram illustrating a flowchart illustrating the operation of the inquiry response management system.

FIG. 4 is a diagram illustrating a touchscreen of a terminal device in a case where a question receiving unit receives a user's question about the position of a mobile object.

FIG. 5 is a diagram illustrating the touchscreen of the terminal device in a case where the question receiving unit receives a user's question about the operation of a device.

FIG. 6 is a diagram illustrating the touchscreen of the terminal device in a case where the question receiving unit receives a user's question about the operating state.

FIG. 7 is a diagram illustrating a state in which the user is being prompted to select one of a plurality of reserved rooms.

FIG. 8 is a diagram illustrating a state after one of the plurality of reserved rooms is selected.

### DETAILED DESCRIPTION

Hereinafter, implementations of the present disclosure will be described with reference to the drawings.

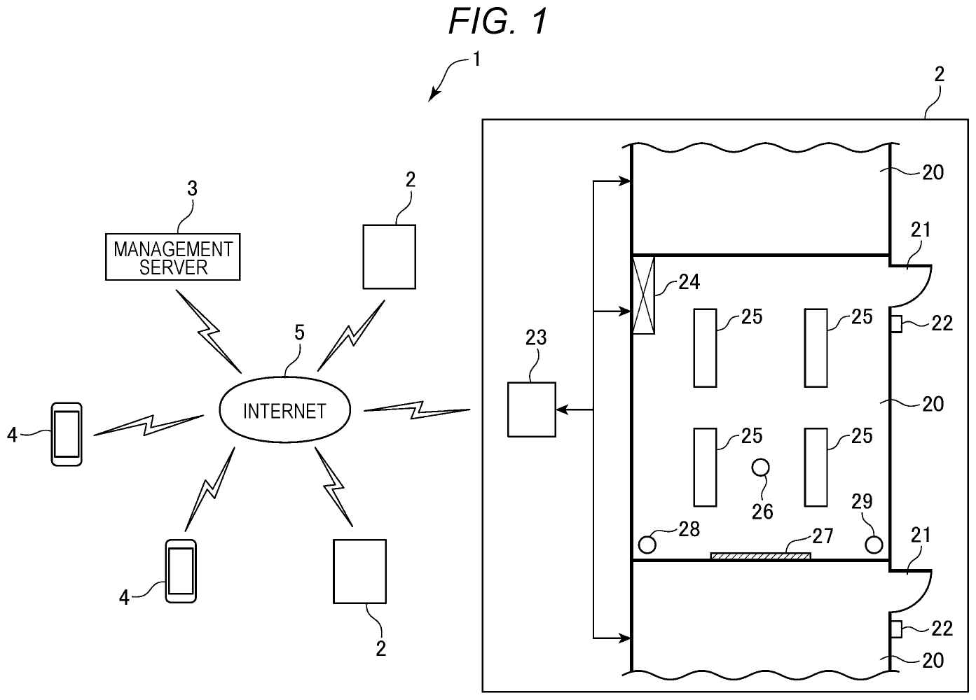

FIG. 1 is a schematic configuration diagram of an inquiry response management system according to an embodiment of the present disclosure.

As illustrated in FIG. 1, an inquiry response management system 1 includes a building 2 having a plurality of rooms 20 (rental spaces) as hourly rental facilities (commodities), a management server 3 that manages the building 2, and a terminal device 4, such as a mobile phone, a smartphone, or a personal computer, that is possessed by a user who wants to use the building 2. The terminal device 4 functions as a user input means that accepts input of information by the user of an hourly rental facility. The building 2, the management server 3, and the terminal device 4 are connected via an Internet 5, which is a public network as a communication line, in such a manner as to communicate with each other.

Each of the rooms 20 includes an entrance 21 and a lock device 22 for locking and unlocking the entrance 21. The lock device 22 is configured in such a manner as to be capable of being unlocked with an unlock key issued from the management server 3 to the user's terminal device 4, for example, a personal identification number, or an optical code such as a barcode or a QR code (registered trademark). The unlock key is changed randomly for each use, and a user who has made a reservation for a particular time can unlock the lock device 22 with a unique unlock key.

Note that in the embodiment, the unlock key adopts, for example, a personal identification number, or an optical code such as a barcode or a QR code (registered trademark). However, biometric recognition such as facial recognition, fingerprint recognition, or retina recognition may be adopted. Anything that can unlock the lock device 22 is acceptable.

The each of the rooms 20 includes a communication terminal device 23, such as a modem or router, that is connected via a local area network (LAN), and devices 24 to 29 connected to the Internet 5 via the communication terminal device 23. In other words, the devices 24 to 29 are connected to the management server 3 via the Internet 5.

The devices 24 to 29 are what are called Internet of Things (IoT) devices, and can transmit and receive various types of information to and from external devices including the management server 3 by being connected to the Internet 5. Therefore, the management server 3 can control the operation of the devices 24 to 29 by transmitting control commands to the devices 24 to 29, and can receive information transmitted from the devices 24 to 29.

Specifically, the device 24 is an air conditioner 24 installed on a wall surface of the room 20, the device 25 is a plurality of lighting devices 25 installed on the ceiling of the room 20, the device 26 is a projector 26 installed on the floor surface of the room 20, and the device 27 is a screen 27 installed on a wall surface of the room 20. Moreover, the device 28 is an air conditioner remote control 28 for operating the air conditioner 24, and the device 29 is a video remote control 29 for operating the projector 26 and the screen 27.

Note that the devices may be IoT devices of types different from the devices 24 to 29, and the each of the rooms 20 may include other devices, for example, furniture such as a desk and chair, a multifunction machine, a whiteboard, and a liquid crystal display, in addition to the IoT devices such as the devices 24 to 29.

A user can access the management server 3 via the Internet 5 by use of the terminal device 4, look for a room 20 that the user wants to use, designate a date and time for use (use start time and use end time), and make a reservation for the room 20.

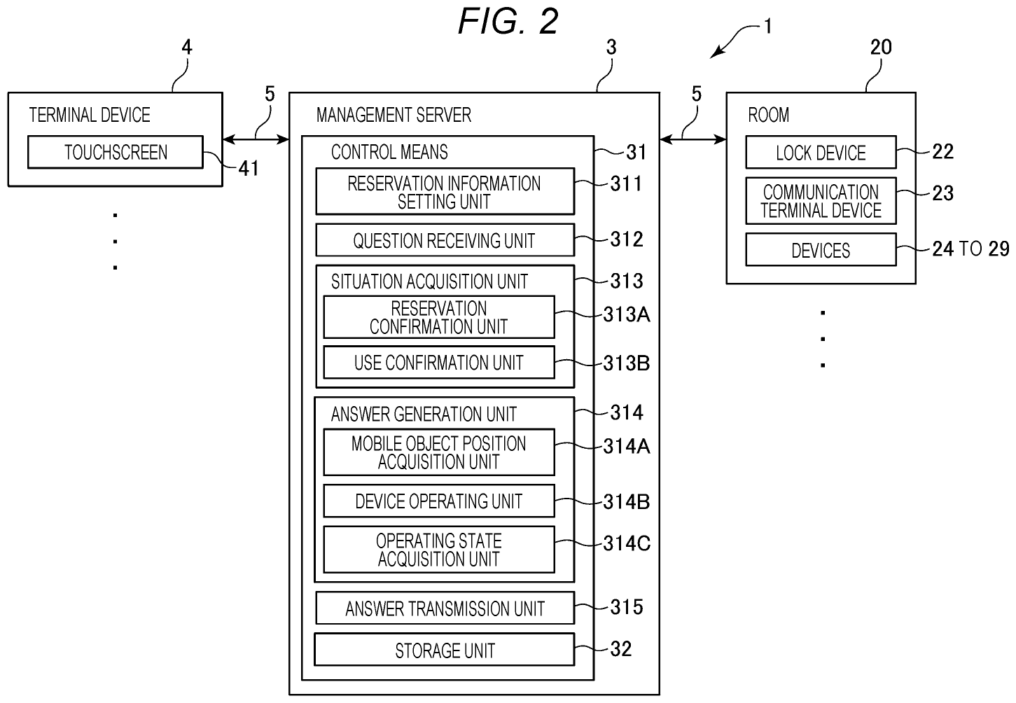

FIG. 2 is a functional block diagram illustrating a schematic configuration of the inquiry response management system.

As illustrated in FIG. 2, the terminal device 4 includes a touchscreen 41. The touchscreen 41 accepts the input of information in accordance with the user's action and provides information as an image to the user.

The management server 3 includes a control means 31. The control means 31 is configured of, for example, a central processing unit (CPU) and memory, and executes information processing in accordance with a predetermined program stored in the memory. The control means 31 includes a reservation information setting unit 311, a question receiving unit 312, a situation acquisition unit 313, an answer generation unit 314, an answer transmission unit 315, and a storage unit 32.

Note that the storage unit 32 is configured of the memory of the control means 31, but may be configured of, for example, a hard disk drive (HDD) or a network attached storage (NAS), or may be configured of a cloud service.

Moreover, the functions of the control means 31 are executed in accordance with programs stored in the storage unit 32. However, the functions may be configured by independent devices, respectively, or may be configured by cloud computing.

Here, the storage unit 32 pre-stores commodity information on the room 20. Specifically, the storage unit 32 pre-stores the commodity information on the room 20, such as the location of the room 20, the positions of the devices 24 to 29 installed in the room 20, the specifications of the devices 24 to 29, use instructions for the devices 24 to 29, and the position of a switch of the lighting devices 25.

The reservation information setting unit 311 accepts a reservation for the room 20 via the terminal device 4 to store and set, in the storage unit 32, reservation information on the user of and the date and time for use (the use start time and the use end time) of the room 20.

The question receiving unit 312 receives a user's question about the room 20 via the terminal device 4.

The situation acquisition unit 313 includes a reservation confirmation unit 313A and a use confirmation unit 313B and, when the question receiving unit 312 receives the user's question, the situation acquisition unit 313 acquires a situation of the user related to the room 20 in accordance with the user's question.

The reservation confirmation unit 313A acquires information on whether or not the user has reserved the room 20, as the situation of the user, based on the user related to the question received by the question receiving unit 312 and the reservation information stored in the storage unit 32. In other words, the reservation confirmation unit 313A acquires the situation of the user related to the reservation information stored in the storage unit 32 in accordance with the user's question.

Specifically, based on the user related to the question received by the question receiving unit 312 and the reservation information stored in the storage unit 32, the reservation confirmation unit 313A acquires information that the user has reserved the room 20, as the situation of the user, when the user related to the question is set in the reservation information, and acquires information that the user has not reserved the room 20, as the situation of the user, when the user related to the question is not set in the reservation information.

When the reservation confirmation unit 313A acquires the information that the user has reserved the room 20, as the situation of the user, the use confirmation unit 313B acquires information on whether or not the user is using the room 20, as the situation of the user.

Specifically, based on a date and time when the question receiving unit 312 received the question and the date and time for use stored in the storage unit 32, the use confirmation unit 313B acquires information that the user is using the room 20, as the situation of the user, when the question receiving unit 312 receives the question between the use start time and the use end time, and acquires information that the user is not using the room 20, as the situation of the user, when the question receiving unit 312 receives the question before the use start time or after the use end time.

Note that, in the embodiment, the use confirmation unit 313B acquires the information on whether or not the user is using the room 20, as the situation of the user, based on the date and time when the question was received by the question receiving unit 312 and the date and time for use stored in the storage unit 32, but may acquire the information on whether or not the user is using the room 20, as the situation of the user, based on other pieces of information.

For example, the use confirmation unit 313B may acquire the position of the user related to the question received by the question receiving unit 312, and acquire the information on whether or not the user is using the room 20, as the situation of the user, based on the position of the user and the position of the reserved room 20. In this case, the use confirmation unit 313B is simply required to acquire the information that the user is using the room 20, as the situation of the user, when the position of the user is in or near the room 20, and to acquire the information that the user is not using the room 20, as the situation of the user, when the position of the user is not in or near the room 20. According to such a configuration, the use confirmation unit 313B functions as a user position acquisition unit.

Here, the use confirmation unit 313B may acquire the position of the room 20 as the position of the user when the lock device 22 of the room 20 is unlocked properly, or may acquire the position of the user by using, for example, information on the position of the terminal device 4.

According to such a configuration, when the lock device 22 of the room 20 is unlocked properly, the use confirmation unit 313B acquires the position of the room 20 as the position of the user. Therefore, it is possible to easily identify the position of the user without providing a new device or function for acquiring the position of the user.

Moreover, the situation acquisition unit 313 is configured in such a manner as to cause the user to select one of the plurality of reserved rooms 20 when acquiring the information that the user has reserved the rooms 20, as the situation of the user, and then the information that the user is not using the rooms 20, as the situation of the user.

Note that, in the embodiment, it is configured in such a manner as to cause the user to select one room 20 when the information that the user is not using the rooms 20 is acquired as the situation of the user. However, it may be configured in such a manner as to cause the user to select one room 20 regardless of whether or not the user is using the rooms 20. In the embodiment, the situation acquisition unit 313 is configured in such a manner as to cause the user to select one of the plurality of reserved rooms 20, but may be configured in such a manner as to cause the user to select a plurality of rooms 20.

The answer generation unit 314 generates an answer to the user's question based on the situation of the user acquired by the situation acquisition unit 313 and the commodity information stored in the storage unit 32. Specifically, when the situation acquisition unit 313 acquires the information that the user has reserved the room 20, as the situation of the user, and then the information that the user is not using the room 20, as the situation of the user, the answer generation unit 314 generates an answer about the reserved room 20. Moreover, when the situation acquisition unit 313 acquires the information that the user is using the room 20, as the situation of the user, the answer generation unit 314 generates an answer about the room 20 currently in use.

Here, the answer generation unit 314 includes a mobile object position acquisition unit 314A, a device operating unit 314B, and an operating state acquisition unit 314C.

The mobile object position acquisition unit 314A acquires the position of a mobile object installed in the room 20. In the embodiment, the mobile object position acquisition unit 314A acquires the positions of the air conditioner remote control 28 and the video remote control 29, which are mobile objects installed in the room 20.

The answer generation unit 314 then generates an answer about the positions of the mobile objects acquired by the mobile object position acquisition unit 314A.

Here, an electronic tag is integrated in each of the air conditioner remote control 28 and the video remote control 29. The mobile object position acquisition unit 314A is configured in such a manner as to be capable of acquiring the positions of the air conditioner remote control 28 and the video remote control 29 by use of the electronic tags.

Note that the mobile object position acquisition unit may adopt any type of configuration as long as it can acquire the position of a mobile object. For example, the mobile object position acquisition unit may be configured in such a manner as to image the interior of the room 20 with an imaging means and acquire the position of a mobile object by image processing.

The device operating unit 314B operates the devices 24 to 29 installed in the room 20. For example, the device operating unit 314B is configured in such a manner as to be capable of operating the projector 26 to switch it on and off, and causing the projector 26 to project a predetermined video.

The answer generation unit 314 then generates answers about the devices 24 to 29 operated by the device operating unit 314B.

The operating state acquisition unit 314C acquires the operating states of the devices 24 to 29 installed in the room 20. The operating state acquisition unit 314C is configured in such a manner as to, for example, when the projector 26 is operated by the device operating unit 314B, be capable of acquiring, as operating states, information on whether or not the projector 26 could be switched on or off properly and whether or not the projector 26 could project a predetermined video.

The answer generation unit 314 then generates answers about the operating states of the devices 24 to 29 acquired by the operating state acquisition unit 314C.

Note that in the embodiment, the answer generation unit 314 includes both the device operating unit 314B and the operating state acquisition unit 314C, but may include only one of the functions.

The answer transmission unit 315 transmits the answers generated by the answer generation unit 314 to the terminal device 4.

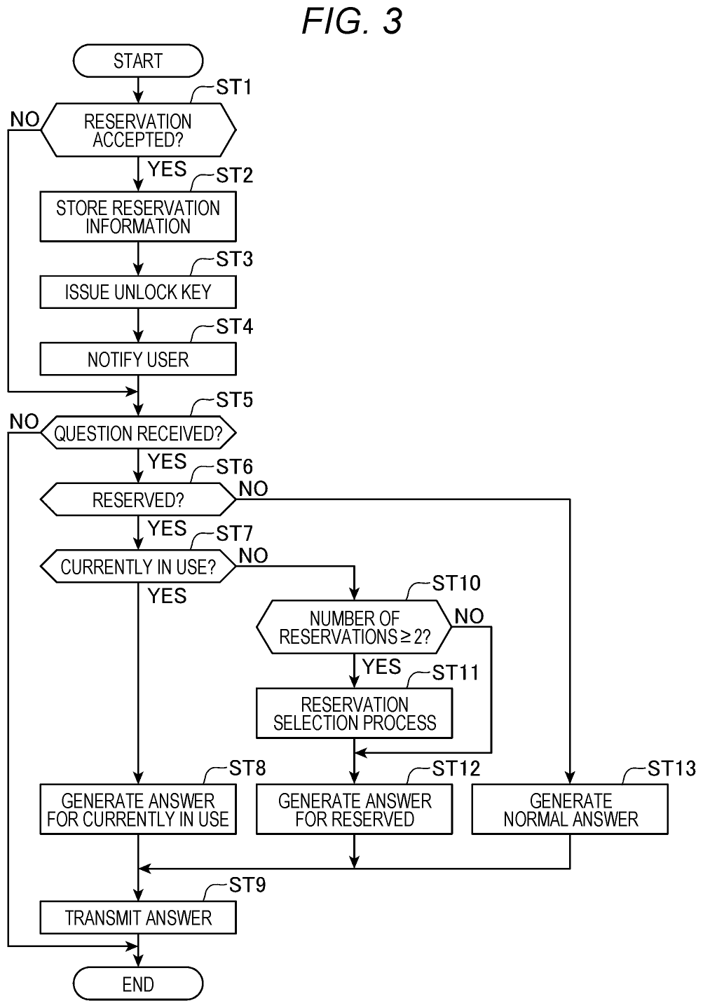

FIG. 3 is a diagram illustrating a flowchart illustrating the operation of the inquiry response management system.

As illustrated in FIG. 3, the control means 31 of the management server 3 repeatedly executes various processes of steps ST1 to ST13 at predetermined time intervals, in accordance with a predetermined program stored in the memory.

As described above, a user of a room 20 can access the management server 3 via the Internet 5 by use of the terminal device 4, look for a room 20 that the user wants to use, designate a time for use, and make a reservation for the room 20.

In step ST1, the control means 31 determines whether or not the reservation for the room 20 has been accepted via the terminal device 4.

When it is determined in step ST1 that the reservation for the room 20 has not been accepted, the control means 31 executes the processes of step ST5 and subsequent steps without executing the processes of step ST2 and subsequent steps.

On the other hand, when it is determined in step ST1 that the reservation for the room 20 has been accepted, the reservation information setting unit 311 stores and sets, in the storage unit 32 in step ST2, reservation information on the user of the room 20 and the date and time for use (the use start time and the use end time) set by the reservation.

After executing the process of step ST2, the control means 31 issues an unlock key that unlocks the lock device 22 of the room 20 to the user based on the reservation information stored in the storage unit 32 in step ST3.

After executing the process of step ST3, the control means 31 notifies the user of the unlock key issued in step ST3 by using, for example, email in step ST4.

After the process of step ST4 is executed, or when it is determined in step ST1 that the reservation for the room 20 has not been accepted, the question receiving unit 312 determines in step ST5 whether or not a user's question about the room 20 has been received via the terminal device 4.

When it is determined in step ST5 that the user's question has not been received, the control means 31 ends the various processes without executing the processes of step ST6 and the subsequent steps.

On the other hand, when it is determined in step ST5 that the user's question has been received, the reservation confirmation unit 313A acquires information on whether or not the user has reserved the room 20, as the situation of the user, based on the user related to the question received by the question receiving unit 312 and the reservation information stored in the storage unit 32, in step ST6.

Specifically, based on the user related to the question received by the question receiving unit 312 and the reservation information stored in the storage unit 32, the reservation confirmation unit 313A acquires information that the user has reserved the room 20, as the situation of the user, when the user related to the question is set in the reservation information, and acquires information that the user has not reserved the room 20, as the situation of the user, when the user related to the question is not set in the reservation information.

When it is determined in step ST6 that the user has reserved the room 20, the control means 31 executes the processes of step ST7 and the subsequent steps.

On the other hand, when it is determined in step ST6 that the user has not reserved the room 20, the control means 31 executes the processes of step ST13 and the subsequent steps.

Firstly, a procedure in a case where it is determined in step ST6 that the user has reserved the room 20 is described.

When it is determined in step ST6 that the user has reserved the room 20, the use confirmation unit 313B acquires information on whether or not the user is using the room 20, as the situation of the user, in step ST7.

Specifically, based on a date and time when the question receiving unit 312 received the question and the date and time for use stored in the storage unit 32, the use confirmation unit 313B acquires information that the user is using the room 20, as the situation of the user, when the question receiving unit 312 receives the question between the use start time and the use end time, and acquires information that the user is not using the room 20, as the situation of the user, when the question receiving unit 312 receives the question before the use start time or after the use end time.

When it is determined in step ST7 that the user is using the room 20, the answer generation unit 314 generates an answer about the room 20 currently in use, in step ST8. The answer transmission unit 315 subsequently transmits the answer generated by the answer generation unit 314 to the terminal device 4, in step ST9. The control means 31 subsequently ends the various processes.

Examples of the answer about the room 20 currently in use are described below.

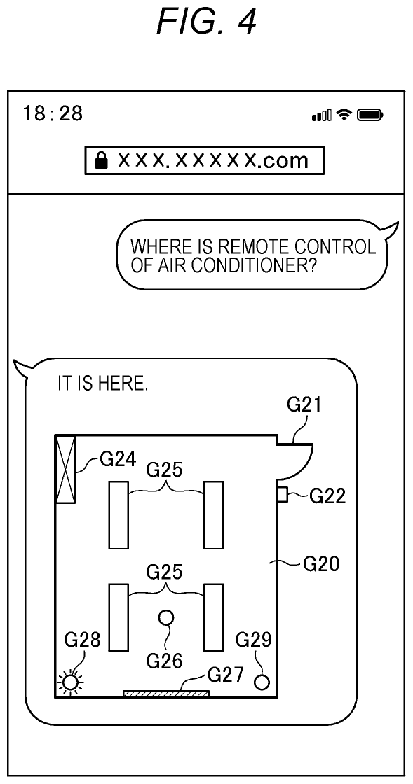

FIG. 4 is a diagram illustrating the touchscreen of the terminal device in a case where the question receiving unit receives a user's question about the position of a mobile object.

For example, as illustrated in FIG. 4, a user operates the touchscreen 41 and thereby can input “Where is the remote control of the air conditioner?” and transmit the question to the management server 3. When the question receiving unit 312 receives such a question from the user, then the mobile object position acquisition unit 314A acquires the position of the air conditioner remote control 28 (a mobile object) installed in the room 20.

The answer generation unit 314 then generates an answer about the position of the air conditioner remote control 28 acquired by the mobile object position acquisition unit 314A, and the answer transmission unit 315 transmits the answer about the position of the air conditioner remote control 28 to the terminal device 4. In the embodiment, the answer generation unit 314 generates an answer in such a manner as to display a map image G20 of the room 20 and device images G24 to G27 of the devices 24 to 27 on the touchscreen 41 of the terminal device 4 and to display a position image G28 indicating the position of the air conditioner remote control 28 in a blinking fashion on the touchscreen 41 of the terminal device 4.

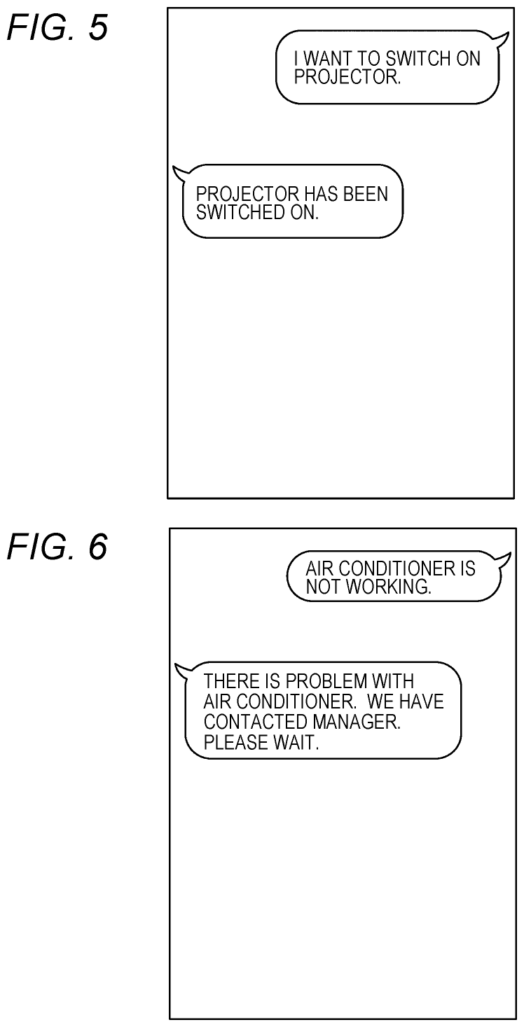

FIG. 5 is a diagram illustrating the touchscreen of the terminal device in a case where the question receiving unit receives a user's question about the operation of a device.

For example, as illustrated in FIG. 5, the user operates the touchscreen 41 and thereby can input “I want to switch on the projector,” and transmit the question to the management server 3. When the question receiving unit 312 receives such a question from the user, then the device operating unit 314B operates the projector 26 installed in the room 20 to switch it on.

The answer generation unit 314 then generates an answer about the projector 26 operated by the device operating unit 314B, and the answer transmission unit 315 transmits the answer about the projector 26 to the terminal device 4. In the embodiment, the answer generation unit 314 generates an answer in such a manner as to display a response: “The projector has been switched on,” as a report to the user, on the touchscreen 41 of the terminal device 4.

Note that, in the embodiment, it is configured in such a manner that questions and responses are inputted and outputted in characters, but it may be configured in such a manner that questions and responses are inputted and outputted by use of another method such as voice.

FIG. 6 is a diagram illustrating the touchscreen of the terminal device in a case where the question receiving unit receives the user's question about the operating state.

For example, as illustrated in FIG. 6, the user operates the touchscreen 41 and thereby can input “The air conditioner is not working,” and transmit the question to the management server 3. When the question receiving unit 312 receives such a question from the user, then the operating state acquisition unit 314C acquires the operating state of the air conditioner 24 installed in the room 20.

The answer generation unit 314 then generates an answer about the operating state of the air conditioner 24 acquired by the operating state acquisition unit 314C, and the answer transmission unit 315 transmits the answer about the operating state of the air conditioner 24 to the terminal device 4. In the embodiment, the answer generation unit 314 generates answers in such a manner as to display responses: “There is a problem with the air conditioner,” and “We have contacted the manager. Please wait,” as reports to the user, on the touchscreen 41 of the terminal device 4.

Moreover, when it is determined in step ST7 that the user is not using the room 20, the situation acquisition unit 313 determines in step ST10 whether or not the number of reservations for rooms 20 made by the user related to the question is two or more.

When it is determined in step ST10 that the number of reservations is two or more, the situation acquisition unit 313 causes the user to select one of the plurality of reserved rooms 20 in step ST11.

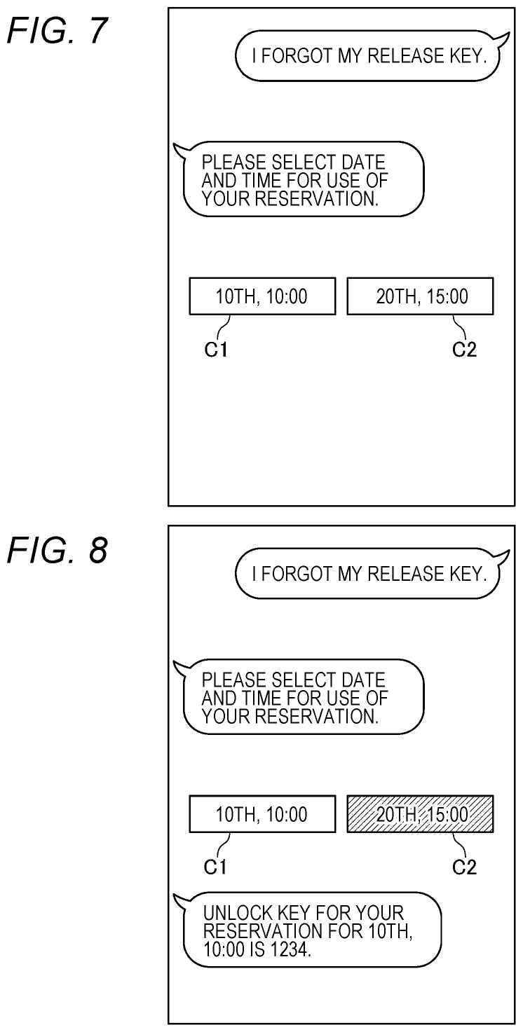

FIG. 7 is a diagram illustrating a state in which the user is being prompted to select one of the plurality of reserved rooms.

For example, as illustrated in FIG. 7, the user operates the touchscreen 41 and thereby can input “I forgot my unlock key,” and transmit the question to the management server 3. When the question receiving unit 312 receives such a question from the user and then it is determined that the user is not using the room 20, the situation acquisition unit 313 determines whether or not the number of reservations for rooms 20 made by the user related to the question is two or more. When it is subsequently determined that the number of reservations is two or more, then the situation acquisition unit 313 displays a response: “Please select the date and time for use of your reservation,” as a report to the user, on the touchscreen 41 of the terminal device 4, and displays choices C1 and C2 that allow the user to select one of the plurality of reserved rooms 20 on the touchscreen 41 of the terminal device 4. In the example of FIG. 7, the choice C1 is a choice indicating a reservation for 10th, 10:00 and the choice C2 is a choice indicating a reservation for 20th, 15:00.

After the process of step ST11 is executed, or when it is determined in step ST10 that the number of reservations is not two or more (when it is determined that the number of reservations is one), the answer generation unit 314 generates an answer about the reserved room 20 in step ST12. The answer transmission unit 315 subsequently transmits the answer generated by the answer generation unit 314 to the terminal device 4, in step ST9 described above. The control means 31 subsequently ends the various processes.

FIG. 8 is a diagram illustrating a state after one of the plurality of reserved rooms is selected.

For example, as illustrated in FIG. 8, the user operates the touchscreen 41 and thereby can select the choice C1 from the choices C1 and C2 and transmit the selection result to the management server 3. In the embodiment, the choice C2, which has not been selected by the user, is grayed out.

The answer generation unit 314 then generates an answer about the room 20 related to the choice C1 selected by the user, and the answer transmission unit 315 transmits the answer about the room 20 related to the choice C1 to the terminal device 4. In the embodiment, the answer generation unit 314 generates an answer in such a manner as to display a response: “The unlock key for your reservation for 10th, 10:00 is 1234,” as a report to the user, on the touchscreen 41 of the terminal device 4.

Next, a procedure in a case where it is determined in step ST6 that the user has not reserved the room 20 is described.

When it is determined in step ST6 that the user has not reserved the room 20, the answer generation unit 314 generates a normal answer in step ST13. The answer transmission unit 315 subsequently transmits the answer generated by the answer generation unit 314 to the terminal device 4, in step ST9 described above. The control means 31 subsequently ends the various processes.

Here, the normal answer is an answer that enables responding appropriately to a human inquiry by causing AI to learn past questions and answers based on a technology such as deep learning, and is similar to a chatbot that uses the known AI technology.

According to such an embodiment, the following operations and effects can be achieved.
(1) The management server 3 includes: the situation acquisition unit 313 that acquires a situation of a user related to a room 20 in accordance with a user's question when the question receiving unit 312 receives the user's question; and the answer generation unit 314 that generates an answer to the user's question based on the situation of the user acquired by the situation acquisition unit 313 and the commodity information stored in the storage unit 32. Therefore, the answer generation unit 314 can appropriately generate an answer to the user's question in accordance with the situation of the user, and the answer transmission unit 315 can transmit the answer to the terminal device 4. Therefore, the inquiry response management system 1 can transmit an appropriate answer to the user's question in accordance with the situation of the user to the terminal device 4, and can improve user convenience.
(2) The situation acquisition unit 313 acquires the situation of the user related to the reservation information stored in the storage unit 32 in accordance with the user's question. Therefore, the answer generation unit 314 can appropriately generate an answer to the user's question in accordance with the situation of the user related to the reservation information stored in the storage unit 32 and further improve user convenience.
(3) If the situation acquisition unit 313 acquires information that the user has reserved the room 20, as the situation of the user, the answer generation unit 314 generates an answer about the reserved room 20. Therefore, for example, information on the location of the reserved room 20, information on an unlock key for using the reserved room 20, and information on the devices 24 to 29 installed in the reserved room 20 or use instructions for the devices 24 to 29 can be generated as the answer to the user's question.
(4) When acquiring information that the user has reserved rooms 20, as the situation of the user, the situation acquisition unit 313 causes the user to select at least one of a plurality of reserved rooms 20. Therefore, it is possible to appropriately answer a question of the user who has reserved the plurality of rooms 20.
(5) When the situation acquisition unit 313 acquires information that the user is using the room 20, as the situation of the user, the answer generation unit 314 generates answers about the room 20 currently in use. Therefore, it is possible to generate information on, for example, the devices 24 to 29 installed in the room 20 currently in use, the positions where the devices 24 to 29 are installed, and use instructions for the devices 24 to 29, as the answers to the user's questions.
(6) The answer generation unit 314 generates an answer about the position of a mobile object acquired by the mobile object position acquisition unit 314A. Therefore, the user can easily grasp the position of the mobile object installed in the room 20.
(7) The management server 3 includes the device operating unit 314B that operates the devices 24 to 29 installed in the room 20, and the answer generation unit 314 generates answers about the devices 24 to 29 operated by the device operating unit 314B. Therefore, it is possible to appropriately answer questions about the operation of the devices 24 to 29 installed in the room 20 by actually operating the devices 24 to 29.
(8) The management server 3 includes the operating state acquisition unit 314C that acquires the operating states of the devices 24 to 29 installed in the room 20, and the answer generation unit 314 generates answers about the operating states of the devices 24 to 29 acquired by the operating state acquisition unit 314C. Therefore, it is possible to appropriately answer questions about malfunctions in the devices 24 to 29 installed in the room 20.

### Alternative Embodiments

Note that the present disclosure is not limited to the above embodiment, and includes modifications and improvements that are made within the scope in which the object of the present disclosure can be achieved.

For example, in the above embodiment, the management server 3 may be configured of a server device of a centralized management type or of a distributed management type. For example, a server that uses a distributed ledger represented by a blockchain can be used.

In the above embodiment, the rooms 20 (hourly rental facilities) of the building 2 are exemplified as commodities. However, the commodities are not limited to, for example, conference rooms and training rooms, and may be, for example, tennis courts, baseball stadiums, athletic fields, and parking lots, which are outdoor spaces, may be, for example, karaoke rooms, rental offices, reading spaces, rental cars, and rental bicycles, may be articles, for example, furniture such as desks and chairs, multifunction machines, whiteboards, and liquid crystal displays, or may be services that use the Internet. Any kind of commodity is acceptable as long as it is an inquiry response target and can aim at commercial transactions. Under the circumstances, the inquiry response management system may be configured in such a manner as to, when commodities with, for example, built-in electronic tags, like the air conditioner remote control 28 and the video remote control 29 in the embodiment, are taken to outside an hourly rental facility or outside a preset area, notify the information to, for example, the user, the manager, the security service company to which the manager has outsourced the work, and furthermore may be configured in such a manner as to be capable of tracking the current location of the commodity with the built-in electronic tag.

In the above embodiment, when it is determined in step ST6 that the user has not reserved the room 20, the answer generation unit 314 generates the normal answer in step ST13.

On the other hand, it may be configured in such a manner that the situation acquisition unit acquires information on whether or not there is a record of a reservation for the facility, as the situation of the user, based on the user related to the question received by the question receiving unit and the reservation information stored in the storage unit and that when the situation acquisition unit acquires information that there is the record of the reservation for the facility, as the situation of the user, the answer generation unit generates an answer about the facility having the record of the reservation.

According to such a configuration, when the situation acquisition unit acquires the information that there is the record of the reservation for the facility, as the situation of the user, the answer generation unit generates an answer about the facility having the record of the reservation. Therefore, it is possible to appropriately answer, for example, a question about the facility that the user used, after the date and time for use.

Moreover, the answer generation unit may be configured in such a manner as to generate an answer about an unlock key for unlocking a lock of the facility, as the answer about the facility having the record of the reservation.

According to such a configuration, the answer generation unit generates an answer about the unlock key for unlocking the lock of the facility, as the answer about the facility having the record of the reservation. Therefore, it is possible to generate an answer about the unlock key, for example, in a case of going back to the facility used by the user to get something that the user left behind, after the date and time for use. Therefore, the inquiry response management system can transmit an appropriate answer to the user's question in accordance with the situation of the user to the user input means, and can improve user convenience.

Moreover, the answer generation unit may be configured in such a manner as to grasp an available time slot(s) for the facility based on the reservation information stored in the storage unit, and generate an answer about an unlock key for unlocking the lock of the facility in the available time slot for the facility.

According to such a configuration, the answer generation unit grasps the available time slot(s) for the facility based on the reservation information stored in the storage unit, and generates an answer about the unlock key for unlocking the lock of the facility in the available time slot for the facility. Therefore, it is possible to prevent generation of an answer about an unlock key for unlocking the lock of the facility that is being used by another user.

Furthermore, the answer generation unit may be configured in such a manner as to cause the user to select at least one of the available time slots for the facility being a target for generating an answer about an unlock key.

According to such a configuration, the answer generation unit causes the user to select at least one of the available time slots for the facility being the target for generating the answer about the unlock key. Therefore, the user can select an available time slot for the facility being the target for generating an answer about an unlock key at his/her own convenience.

In the above embodiment, when it is determined in step ST7 that the user is using the room 20, the answer generation unit 314 generates an answer about the room 20 currently in use in step ST8.

On the other hand, the answer generation unit may be configured in such a manner as to, when the situation acquisition unit acquires information that the user is using the commodity, as the situation of the user, generate an answer about an extension to the use time of the commodity currently in use.

According to such a configuration, when the situation acquisition unit acquires the information that the user is using the commodity, as the situation of the user, the answer generation unit generates an answer about the extension to the use time of the commodity currently in use. Therefore, the user can inquire and check whether or not the use time of the commodity currently in use can be extended.

Moreover, the answer generation unit may be configured in such a manner as to grasp an available time slot(s) for the commodity based on the reservation information stored in the storage unit and to cause the user to select whether or not to extend the use time based on the available time slot(s) for the commodity.

According to such a configuration, the answer generation unit grasps the available time slot(s) for the commodity based on the reservation information stored in the storage unit, and causes the user to select whether or not to extend the use time based on the available time slot(s) for the commodity. Therefore, the user can make an arrangement to extend the use time by selecting whether or not to extend the use time via the inquiry response management system.

The foregoing description has been described with reference to specific implementations. However, the illustrative discussions above are not intended to be exhaustive or to limit the claims to the precise forms disclosed. Many variations are possible in view of the above teachings. The implementations were chosen and described to best explain principles of operation and practical applications, to thereby enable others skilled in the art.

The various drawings illustrate a number of elements in a particular order. However, elements that are not order dependent may be reordered and other elements may be combined or separated. While some reordering or other groupings are specifically mentioned, others will be obvious to those of ordinary skill in the art, so the ordering and groupings presented herein are not an exhaustive list of alternatives.

As used herein: the singular forms “a”, “an,” and “the” include the plural forms as well, unless the context clearly indicates otherwise; the term “and/or” encompasses all possible combinations of one or more of the associated listed items; the terms “first,” “second,” etc. are only used to distinguish one element from another and do not limit the elements themselves; the term “if” may be construed to mean “when,” “upon,” “in response to,” or “in accordance with,” depending on the context; and the terms “include,” “including,” “comprise,” and “comprising” specify particular features or operations but do not preclude additional features or operations.

What is claimed is:

1. An inquiry response management system comprising:
a management server configured to manage commodities being inquiry response targets; and
a user input means connected to the management server via a communication line and configured to accept input of information by a user of a commodity, wherein
the management server includes:
a storage unit configured to store commodity information on the commodities;
a question receiving unit configured to receive a user's question about the commodity via the user input means;
a situation acquisition unit configured to, upon the question receiving unit receiving the user's question, acquire a situation of the user related to the commodity in accordance with the user's question;
an answer generation unit configured to generate an answer to the user's question based on the situation of the user acquired by the situation acquisition unit and the commodity information stored in the storage unit; and
an answer transmission unit configured to transmit the answer generated by the answer generation unit to the user input means.

2. The inquiry response management system according to claim 1, wherein
the management server includes a reservation information setting unit configured to store and set, in the storage unit, reservation information on the user of and a date and time for use of the commodity by accepting a reservation for the commodity via the user input means, and
the situation acquisition unit acquires the situation of the user related to the reservation information stored in the storage unit in accordance with the user's question.

3. The inquiry response management system according to claim 2, wherein
the situation acquisition unit acquires information on whether or not the user has reserved the commodity, as the situation of the user, based on the user related to the question received by the question receiving unit and the reservation information stored in the storage unit, and
the answer generation unit generates an answer about the reserved commodity upon the situation acquisition unit acquiring information that the user has reserved the commodity, as the situation of the user.

4. The inquire response management system according to claim 3, wherein upon acquiring information that the user has reserved commodities, as the situation of the user, the situation acquisition unit causes the user to select at least one of a plurality of the reserved commodities.

5. The inquiry response management system according to claim 3, wherein
upon acquiring the information that the user has reserved the commodity, as the situation of the user, the situation acquisition unit acquires information on whether or not the user is using the commodity, as the situation of the user, based on a date and time when the question receiving unit received the question and a date and time for use stored in the storage unit, and
upon the situation acquisition unit acquiring information that the user is using the commodity, as the situation of the user, the answer generation unit generates an answer about the commodity currently in use.

6. The inquiry response management system according to claim 3, further comprising:
a facility as a commodity connected to the management server and the user input means via the communication line, wherein
the management server includes a user position acquisition unit configured to acquire a position of the user related to the question received by the question receiving unit,
upon acquiring information that the user has reserved the facility, as the situation of the user, the situation acquisition unit acquires information on whether or not the user is using the facility, as the situation of the user, based on the position of the user acquired by the user position acquisition unit and a position of the reserved facility, and
upon the situation acquisition unit acquiring information that the user is using the facility, as the situation of the user, the answer generation unit generates an answer about the facility currently in use.

7. The inquiry response management system according to claim 6, wherein
the facility includes a lock device that locks and unlocks the facility, and
upon the lock device of the facility being unlocked properly, the user position acquisition unit acquires the position of the facility as the position of the user.

8. The inquiry response management system according to claim 6, wherein
the management server includes a mobile object position acquisition unit configured to acquire a position of a mobile object installed in the facility, and
the answer generation unit generates an answer about the position of the mobile object acquired by the mobile object position acquisition unit.

9. The inquiry response management system according to claim 6, wherein
the management server includes a device operating unit configured to operate a device installed in the facility, and
the answer generation unit generates an answer about the device operated by the device operating unit.

10. The inquiry response management system according to claim 6, wherein
the management server includes an operating state acquisition unit configured to acquire an operating state of the device installed in the facility, and
the answer generation unit generates an answer about the operating state of the device acquired by the operating state acquisition unit.

11. The inquiry response management system according to claim 5, wherein upon the situation acquisition unit acquiring the information that the user is using the commodity, as the situation of the user, the answer generation unit generates an answer about an extension to a use time of the commodity currently in use.

12. The inquiry response management system according to claim 11, wherein the answer generation unit grasps an available time slot(s) for the commodity, based on the reservation information stored in the storage unit, and causes the user to select whether or not to extend the use time, based on the available time slot(s) for the commodity.

13. The inquiry response management system according to claim 2, further comprising:
a facility as a commodity connected to the management server and the user input means via the communication line, wherein
the situation acquisition unit acquires information on whether or not there is a record of a reservation for the facility, as the situation of the user, based on the user related to the question received by the question receiving unit and the reservation information stored in the storage unit, and
upon the situation acquisition unit acquiring information that there is the record of the reservation for the facility, as the situation of the user, the answer generation unit generates an answer about the facility having the record of the reservation.

14. The inquiry response management system according to claim 13, wherein the answer generation unit generates an answer about an unlock key for unlocking a lock of the facility, as the answer about the facility having the record of the reservation.

15. The inquiry response management system according to claim 14, wherein the answer generation unit grasps an available time slot(s) for the facility based on the reservation information stored in the storage unit, and generates an answer about an unlock key for unlocking the lock of the facility in the available time slot for the facility.

16. The inquiry response management system according to claim 15, wherein the answer generation unit causes the user to select at least one of the available time slots for the facility being a target for generating the answer about the unlock key.
